(19) United States
(12) Patent Application Publication
(10) Pub. No.: US 2011/0204308 A1
(43) Pub. Date: Aug. 25, 2011

(54) RAILING AND METHOD OF MANUFACTURE

(76) Inventors: Willard Adkins, Land O' Lakes, FL (US); Fredrich M. Hilpert, Brooksville, FL (US)

(21) Appl. No.: 13/032,275

(22) Filed: Feb. 22, 2011

Related U.S. Application Data
(60) Provisional application No. 61/307,753, filed on Feb. 24, 2010.

(51) Int. Cl. E04H 17/14; B23P 11/00

(52) U.S. Cl. 256/65.02; 29/525.14

(57) ABSTRACT

A railing and method of manufacturing the railing provide for a guard rail having an upper and lower railing and pickets extending between the upper and lower railing joined to posts such that a rib extends from a surface of one or both of the railings bites into an end of the pickets preventing chattering. The method may use a jig to clamp the railings and pickets together during joining to the posts, such as by welding

### REFERENCE TO RELATED APPLICATION

This application claims the benefit of the filing date of U.S. Provisional Patent Application No. 61/307,753 filed Feb. 24, 2010, the description and figures of which are hereby incorporated by reference in its entirety.

### FIELD OF THE INVENTION

The field is railing, particularly pedestrian guardrails with vertical pickets.

### BACKGROUND

Pedestrian guardrails with vertical pickets are known and used in private and public works projects, but such rails require cutting and welding of structures on the jobsite in order to fit the rails to terrain and to mounting structures.

### SUMMARY OF THE INVENTION

A method of manufacturing a railing assembly comprises a system of assembly that provides a railing assembly easily installed on a jobsite, reducing labor costs and time for installation. A plurality of holes is formed in a lower channel and an upper channel, such as by punching. The lower channel is fitted into a lower rail, and the upper channel is fitted into the upper rail, such as by snapping. A plurality of pickets is positioned in each of the plurality of holes in the upper channel and the lower channel, forming a rails and pickets assembly. The rails and pickets assembly is mounted in a jig, such that a flat surface of the upper rail and a flat surface of the lower rail are exposed. A plurality of posts are disposed at a beam spacing distance of the jig such that a flat portion of each of the posts contacts the flat surfaces of the upper rail and the flat surface of the lower rail. Then, each of the posts are joined to the upper rail and the lower rail such that the rails and pickets assembly is permanently joined together, such as by welding of the flat portion of each of the posts to the flat surface of the upper rail and the flat surface of the lower rail.

In one example, snap fit connectors are formed on an underside of a shaped, tubular rail for each of the upper rail and lower rail, which are identical, and the U-shaped channels, which are also identical for the lower and upper channels, have corresponding snap fit connectors extending from each end of a U-shaped channel profile of the channels, such that snap fit connectors of the channels snap over the snap fit connectors extending from the underside of the tubular rails. For example, the snap fit connectors and the rails may be formed such that a portion of the rails and a side of the channels form a flat, planar surface, allowing a welding bead to join a flat portion of a post and the flat, planar surface of both the rail and channel.

Chattering caused by movement of metal pickets in the channel may be suppressed by a raised rib extending from the underside surface of the rails, such that the raised rib bites into a surface of each of the pickets when the rail assembly is clamped together and welded to the posts. Surprisingly, no other attachment or device is needed to suppress chattering, and the raised rib is easily formed in the surface of the rail during forming of the tubular profile without the addition of a significant volume of metal, such as formable alloys of aluminum, magnesium, steel, titanium or the like. Preferably, a heat treatable and weldable metal having a good formability is used in the manufacturing of the components of the railing assembly.

One advantage of the railing assembly and method of manufacture is that the design is manufacturable from simple extrusions with minimal post extrusion machining, stamping and welding. Another advantage is that the railing assembly may be installed by bolting the base plates to fixtures cast into footings in the ground. Yet another advantage is that time and labor costs for installing railing assemblies to complete a project are reduced compared to known railings that require cutting and/or more complicated assembly at the jobsite and/or more complicated welding operations and installation steps. Still another advantage, which is surprising and unexpected, is that the costs of materials and assemblies are reduced compared to known railings due to efficiencies in use of materials and fabrication of the assemblies. Surprisingly, the ornamental design of the railings is highly attractive and distinctive without introducing substantial additional costs for materials and labor and while substantially reducing such costs in comparison with known railings of comparable quality and aesthetic appeal.

### BRIEF DESCRIPTION OF THE DRAWINGS

FIG. 1 illustrates a front plan view of a plurality of railing assemblies formed according to a method of manufacturing a railing assembly and joined together in an installation.

FIG. 2 illustrates a top plan view of the installation illustrated in FIG. 1.

FIG. 3 illustrates a side plan view of one end of a railing assembly mounted to a post.

FIG. 4 illustrates a detailed, back plan view of a post having an end cap joined to a portion of a railing assembly (pickets intentionally omitted for clarity).

FIG. 5 illustrates a detailed, front plan view of a post joined to a portion of a railing assembly (pickets intentionally omitted for clarity).

FIG. 6 illustrates a detailed, partial cross sectional view of an upper rail, an upper channel and a portion of a picket.

FIG. 7 illustrates a detailed, partial cross sectional view of a post welded to a base plate and a block.

FIG. 8 illustrates a detailed view of an expansion joint.

FIG. 9 illustrates a detailed cross sectional view of an expansion joint.

FIG. 10 illustrates an exploded, detailed view of and end section and a portion of a railing assembly.

FIG. 11 illustrates a tubular pipe having a circular cross section.

FIG. 12 illustrates a cross sectional, exploded view of a rail and channel.

FIG. 13 illustrates an end view of a splicing member.

FIG. 14 illustrates a cross sectional view of a post.

FIG. 15 illustrates an end view of a picket.

FIG. 16 illustrates a top view of an example of a post mounted on a base plate.

### DETAILED DESCRIPTION

The examples described and the drawings rendered are illustrative and are not to be read as limiting the scope of the invention as it is defined by the appended claims.

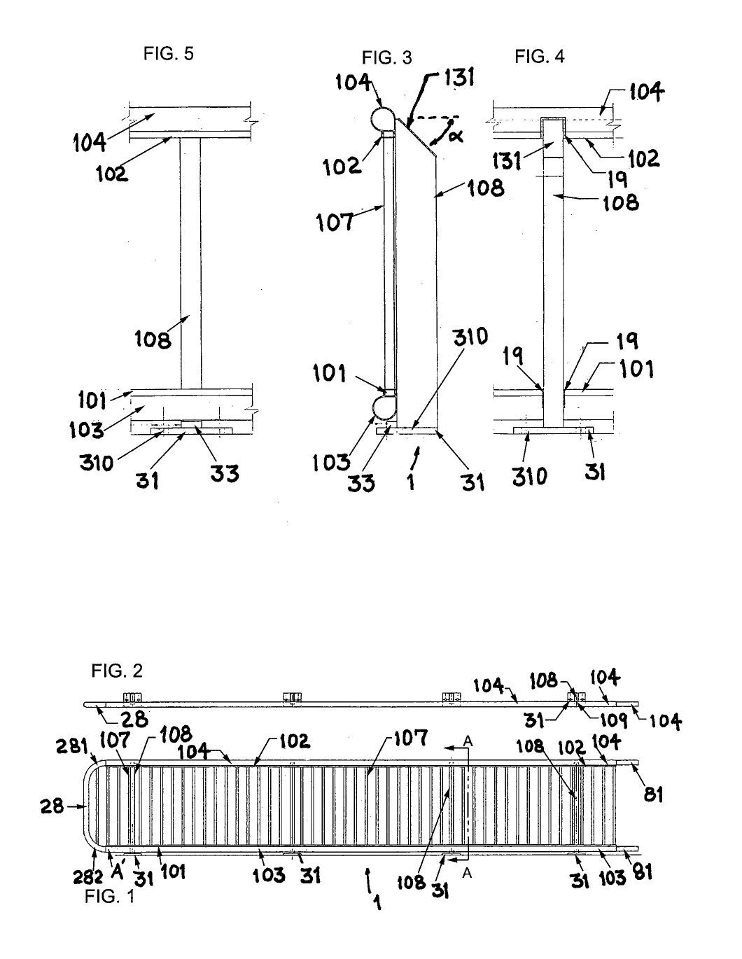

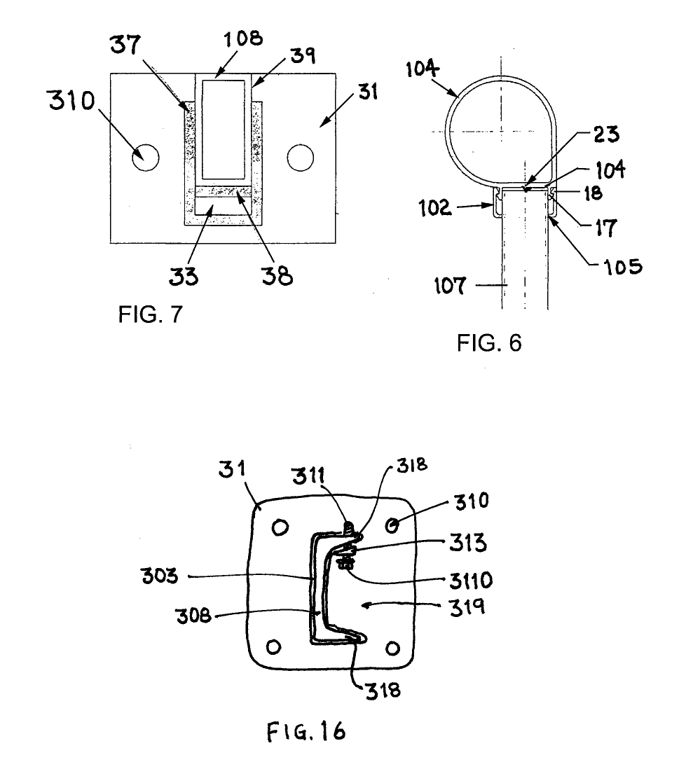

A method of manufacturing a railing assembly as illustrated in the drawings of FIGS. 1-15 comprises a system of assembly that provides a railing assembly 1 easily installed on a jobsite, reducing labor costs and time for installation. A plurality of holes 105 are punched in a lower channel and an upper channel 101, 102, which may be identical parts. The lower channel 101 is snapped onto a lower rail 103, and the upper channel 102 is snapped onto the upper rail 104. The upper and lower rails may be identical parts. A plurality of pickets 107 are positioned in each of the plurality of holes 105 in the upper channel and the lower channel, forming a rails and pickets assembly. The rails and pickets assembly is mounted in a jig, such that a flat surface 109 of the upper rail and a flat surface 109 of the lower rail are exposed. A plurality of posts 108 are disposed at a beam spacing distance of the jig such that a flat portion of each of the posts 108 contacts the flat surfaces 109 of the upper rail 104 and the lower rail 103. Then, each of the posts 108 are joined to the upper rail 104 and the lower rail 103 such that the rails and pickets assembly is permanently joined together, such as by welding of the flat portion of each of the posts 108 to the flat surface 109 of the upper rail 104 and the flat surface 109 of the lower rail 103.

In one example, the flat surface 109 of the upper rail 104 includes a portion 109 of the upper rail 104 and a portion of the upper channel 102, and the flat surface of the lower rail 103 includes a portion of the lower rail and a portion of the lower channel 101. In one example, snap fit connectors 17 are formed on an underside of a shaped, tubular rail for each of the upper rail 104 and lower rail 103, which are identical, and the U-shaped channels 101,102, which are also identical for the lower and upper channels, have corresponding snap fit connectors 18 extending from each end of a U-shaped channel profile of the channels, such that snap fit connectors 18 of the channels 101,102 snap over the snap fit connectors 17 extending from the underside of the tubular rails. For example, the snap fit connectors 17 and the rails 103,104 may be formed such that a portion of the rails and a side of the channels form a flat, planar surface, allowing a welding bead 19 to join a flat portion of a post and the flat, planar surface of both the rail and channel, as illustrated in FIGS. 4, 6 and 12, for example.

In one example, a rib 23 is formed on a bottom surface of the upper rail 104, extending from the bottom surface of the upper rail 104 and extending longitudinally along a length of the upper rail, and the rails and pickets assembly is mounted into the jig such that the rib 23 bites into an upper surface of each of the plurality of pickets 107, when the pickets 107 are fitted into holes 105 formed in the upper and lower channels. For example, a clamping force pushes the rib 23 into contact with a portion of the surface at an end of each of the plurality of pickets 107 such that the rib 23 bites into the end surface of each of the plurality of pickets 107 locking the plurality of pickets 107 into intimate contact with the rib 23, after the joining process between the posts 108 and the rails 103,104 is completed.

In one example, a lower end of each of the plurality of posts 108 is joined to a base plate 31, and each of the base plates 31 are fixed to one of a plurality of fixtures using a fastener to a threaded stud extending through holes 310 for supporting the plurality of posts 108. For example, the lower end of each of the plurality of posts 108 may be welded to the base plate 31, and the step of welding may include a weldment 38 from a forward portion of each of the plurality of posts 108 along a side portion 37 of each of the plurality of posts in contact with one of the base plates 31, stopping at a distance from a back surface of each of the plurality of posts leaving a segment 39 of the post without a weld. A block 33 may be welded to the forward portion of each of the plurality of posts 108 reinforcing the strength of the joint between each of the plurality of posts 108 and its respective base plate 31, the block 33 being joined to the respective base plate 31, such as by welding or adhering of the block 33 to the base plate 31, for example. In one example, friction stir welding is used to join at least one portion of the block 33 or the post 108 to the base plate 31.

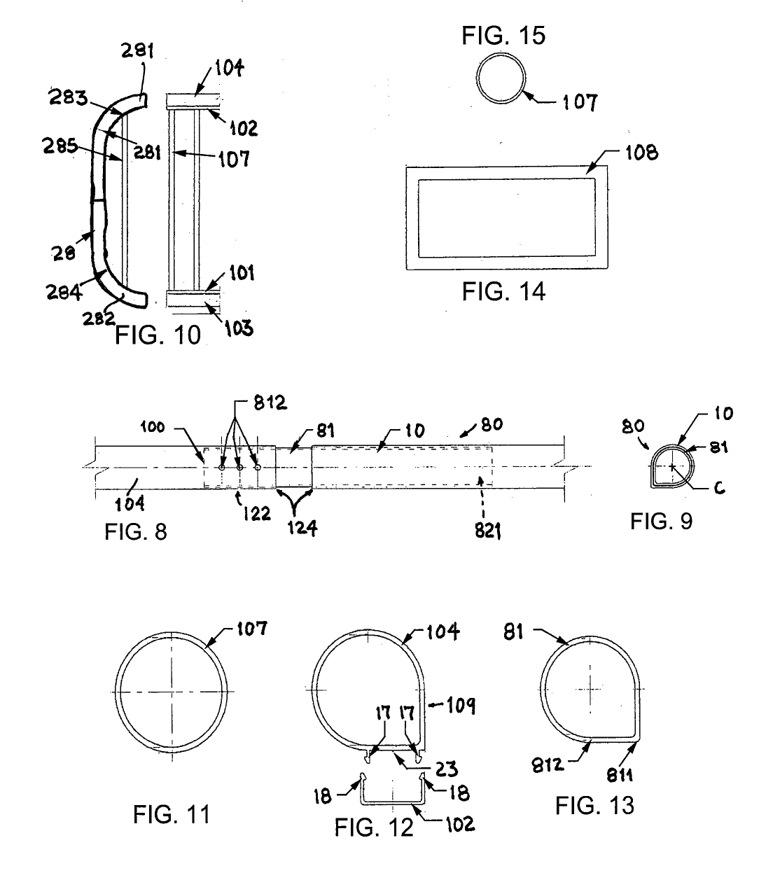

In one example, a rail expansion joint 80, such as illustrated in FIGS. 8 and 9, is used to join a first railing assembly 100 to second railing assembly 10. For example, a plurality of splicing members 81 may be made that are each insertable into the lower rails 103 and the upper rails 104. For example, the splicing members 81 may have the same cross sectional shape as both the lower rails 103 and the upper rails 104, which lower rails and upper rails may be identical, in one example. One end of the splicing member 81 may be inserted into an upper rail 104 and may be plug welded at one or more holes 812 formed in an end portion 122 of the upper rail 104. The same may be accomplished for the lower rail 103. The opposite end 821 of the splicing members 81 may be inserted into the respective upper rail and lower rail of a second railing assembly 10 positioned adjacent to the first 100. By not welding the splicing member 81 to the second railing assembly 10, the splicing member 81 provides a slip fit allowing for thermal expansion, settling and other relative motion between the first railing assembly 100 and the second railing assembly 10. A bevel or rounded edge 124 of the each of the upper and lower rails of the railing assemblies joined by expansion joints may provide for a continuous appearance at the expansion joint. An elbow 811 of the splicing member 81 is rounded to fit the profile of the rail 104. The inflection point 812 is likewise designed for insuring a good fit with the rail 103,104.

An end section may include a tubular assembly 28 having opposite ends 281,282, each insertable into one of the upper rail 104 or the lower rail 103, such as illustrated in FIGS. 1, 2 and 10. The tubular assembly may include arcuate portions 283,284 extending from each of the opposite ends 281,282 and an elongated linear portion 280 extending between the arcuate portions 283,284, such that one of the opposite ends 281 may be fitted into the upper rail 104 of a railing assembly 100, and the opposite end 282 of the tubular assembly from the first of the opposite ends 281 may be fitted into an end of the lower rail 103 of the same railing assembly 100, such as illustrated in the detail of FIG. 10, for example. In one example, a picket 285 extends from the first arcuate portion 283 to an opposite arcuate portion 284 of the end section 28. The opposite ends 281,282 of the end section 28 may have the same cross sectional tubular shape as the upper and lower rails 103,104 but may be sized to be readily insertable into the tubular upper and lower rails in a similar fashion to the splicing member 81 illustrated in FIGS. 9 and 13, for example.

FIG. 15, illustrates a view of the end of a picket 107, 285 having a round tubular cross section, as illustrated in detailed view of FIG. 11.

In one example, a picket 107 may substantially overlap with a post 108, as illustrated in FIG. 1, which shows pickets 107 adjacent to or overlapping various posts 108 extending upward from base plates 31. Each post may have an end 131 opposite of the base plate 31 that is cut at an angle and between 10° and 75° from the horizontal direction to the post width.

In an alternative example, a base plate 31 is attached to a post 108 by welding the post 108 around the outer peripheral perimeter of a post 108 with a square cross section, such as illustrated in FIG. 14, or with a cross section of a C-beam 308 or an I-beam as illustrated in the example of FIG. 16. The weldment 303 may attach the C-beam 308 to the plate, and the C-beam 308 may be joined to rail 103,104 using a bolt 311 and shaped spacer 313 with the bolt threadingly engaging one or both of the rails 103,104 after passing through a hole in the spacer 310. A cover 309 may conceal the bolts 311. The bolt or bolts 311 may be concealed within a cavity formed by opposite end 318 of the C-beam each of the ends 318 comprising a flat portion. One of the flat portions of the ends 318 is arranged to contact one or more rails. The inner cavity 319 is defined by a first end 318 and a second end opposite of the first end, both extending transversely, outwardly in the same direction in relation to the base plate 31 and the connection member of the C-beam post.

The outer surface of the two ends are substantially parallel in this example, but the inner opposing faces of the two ends diverge in a direction away from each other. The spacer 313 is selected to have an angle that is substantially the same as the angle between an outer facing surface of an end of the C-beam and an inner facing surface the same end such that the spacer can be arranged to provide a substantially flat contact surface for a bolt head 3011 of a bolt 311 passing through a hole in the end 318 of the C-beam 308.

1. A method for manufacturing a railing assembly comprises:
forming a plurality of holes in a lower channel and an upper channel; fitting the lower channel into a lower rail and the upper channel into the upper rail;
positioning a plurality of pickets in each of the plurality of holes in the lower channel and the upper channel within a jig such that a flat portion of the lower rail and upper rail is exposed and the lower rail, the pickets and the upper rail are compressed into contact;
joining a plurality of posts to the flat portion of the lower rail and the upper rail such that the railing assembly is fixedly joined.

2. The method of claim 1, wherein the step of joining includes welding each of the plurality of posts to the flat portion of the lower rail and the upper rail.

3. The method of claim 2, wherein the step of joining includes welding each of the plurality of posts to a flat portion of the lower channel and the upper channel aligned in the same plane as the flat portion of the lower rail and the upper rail.

4. The method of claim 1, wherein the steps of positioning includes clamping the lower rail, the pickets, and the upper rail such that a rib extending from a surface of the upper rail, the lower rail or both the upper rail and the lower rail bites into a respective contact surface of each of the plurality of pickets.

5. The method of claim 4, wherein the step of clamping causes the rib extending from the surface of the upper rail and the lower rail to bite into the respective contact surface at opposite ends of each of the plurality of pickets.

6. The method of claim 1, further comprising:
welding a base plate to a lower end of each of the plurality of posts.

7. The method of claim 6, further comprising:
bolting each of the base plates to a fixture for supporting the rail assembly in an installation.

8. The method of claim 6, wherein the step of welding the base plate welds from a first surface of each of the plurality of posts along a side of each of the plurality of posts, stopping at a distance from a second surface of each of the plurality of posts.

9. The method of claim 8, wherein the step of stopping included in the step of welding the base plate leaves at least 2 centimeters from the second surface on the side of each of the plurality of posts unwelded.

10. An installation comprising a plurality of rail assemblies bolted to fixtures according to the method of claim 8 such that each of the plurality of rail assemblies are aligned longitudinally and each of the base plates are bolted to a respective fixture arranged in a row of fixtures.

11. The installation of claim 10, further comprising a rib extending from a surface of the upper rail or the lower rail compressively biting into a respective contact surface at one end of a picket extending through a hole formed in a channel fitted to the upper rail or the lower rail and extending between the upper rail and the lower rail.

12. The installation of claim 11, wherein the rib extends from the surface of the upper rail, the rib compressively biting into the respective contact surface at one end of the picket extending through the hole formed in the channel fitted to the upper rail.

13. The installation of claim 12, wherein another rib extends from a surface of the lower rail, compressively biting into the respective contact surface at an opposite end of the picket, opposite from the one end, and extending through a hole formed in a channel fitted to the lower rail.

14. A rail for use in manufacturing a railing assembly, comprising:
a flat exterior portion;
an arcuate portion extending arcuately away from the plane of the flat portion such that the flat exterior portion, the arcuate portion and a channel locking portion forms a tube having two open ends at opposite longitudinal ends and a closed tubular surface extending between the two open ends at opposite longitudinal ends of the tube; and
the channel locking portion comprises a pair of locking extensions extending along the length of the tube and a surface of a channel locking portion extending between the arcuate portions of the tube.

15. The rail of claim 14, further comprising a post comprising a C-beam, wherein the C-beam is joined to a base plate at one end of the C-beam, and the rail is attached to the C-beam.

16. The rail of claim 15, wherein the C-beam is attached to the rail using a fastener.

17. The rail of claim 16, wherein the fastener includes a shaped spacer through which a threaded portion of a bolt passes such that a head of the bolt engages a flat surface of the spacer and a shape of the shaped spacer accommodates an uneven surface of the C-beam through which the bolt passes to engage the rail.

18. The rail of claim 17, wherein the head of the bolt is concealed by a cover plate attached to the C-beam.

19. The rail of claim 18, wherein the cover plate is attached to opposite ends of the C-beam by welding of the cover plate to the opposite ends enclosing the head of the bolt within a cavity formed by the opposite ends of the C-beam.

20. The rail of claim 14, wherein the rail comprises two identical rail structures disposed one above the other, and a plurality of pickets extending between the two identical rail structures, and the plurality of pickets extend through a plurality of pre-cut holes in a pair of opposite snap caps, each snappingly engaging one of the pair of locking extensions of a respective one of the channel locking portions to which the respective one of the pair of opposite snap caps is snappingly engaged.

21. The method of claim 4, wherein the step of fitting includes selecting the upper rail according to the rail of claim 14, and the step of positioning includes clamping the upper rail according to the rail of claim 14 such that the biting edge profile of the rib bites the tip of the rib into the respective contact surface of each of the plurality of pickets, compressedly deforming the tip of the rib, the respective contact surface of each of the plurality of pickets or both thereof.
